(19) United States
(12) Patent Application Publication
(10) Pub. No.: US 2019/0057476 A1
(43) Pub. Date: Feb. 21, 2019

(54) SYSTEM AND METHOD FOR REDUCING WAIT TIME IN PROVIDING TRANSPORTATION SERVICE

(71) Applicant: BEIJING DIDI INFINITY TECHNOLOGY AND DEVELOPMENT CO., LTD., Beijing (CN)

(72) Inventors: Niping ZHANG, Beijing (CN); Lu LI, Beijing (CN); Guojun LI, Beijing (CN); Mingshan LUO, Beijing (CN); Meichen LIU, Beijing (CN)

(73) Assignee: BEIJING DIDI INFINITY TECHNOLOGY AND DEVELOPMENT CO., LTD., Beijing (CN)

(21) Appl. No.: 15/848,457

(22) Filed: Dec. 20, 2017

(30) Foreign Application Priority Data
Aug. 16, 2017 (CN) 201710700607.4

(51) Int. Cl. G06Q 50/30; G06Q 30/06; G07B 15/00

(52) U.S. Cl. CPC G06Q 50/30; G06Q 30/0627; G07B 15/00; G06Q 30/0613

(57) ABSTRACT

Embodiments of the disclosure provide methods and systems for providing transportation service. The method may include receiving a first transportation service request from a remote passenger terminal and determining a first estimated waiting time of the first transportation service request by a processor. The method may further include determining that the first estimated waiting time is greater than a first predetermined time period by the processor, and generating a second transportation service request comprising a transportation parameter different from that of the first transportation service request by the processor.

### CROSS REFERENCE TO RELATED APPLICATION

The present application is based on and claims the benefits of priority to Chinese Application No. 201710700607.4, filed Aug. 16, 2017, the entire contents of which are incorporated herein by reference.

### TECHNICAL FIELD

The present disclosure relates to providing transportation service, and more particularly to, methods and systems for modifying a transportation service request.

### BACKGROUND

An online hailing platform (e.g., DiDi™ online) can receive a transportation service request from a passenger and then route the service request to at least one transportation service provider (e.g., a taxi driver, a private car owner, or the like). The service request can be picked up by a service provider, or assigned to a service provider if no one picks up the service request within a predetermined period.

When the online hailing platform receives transportation service requests more than the transportation capacity that the service vehicles can offer at the current moment (e.g., in rush hours), the transportation service requests can be lined up in a queue, where the service vehicles can be assigned with the transportation service requests according to a predetermined regulation. Therefore, in rush hours, a passenger may have to wait in a queue for a long time until his transportation service request is assigned to a vehicle. It is expected to reduce the waiting time for the passenger and make best use of all transportation capacities.

A transportation service request associates with many transportation parameters, such as request area, vehicle type (e.g., taxi, ordinary car, luxury car, bus) and carpooling option. Usually a passenger may send out a transportation service request according to his preference, without knowing the status of all service vehicles. For example, a passenger who has been waiting for a long time for an ordinary car within three kilometers of distance may not know his transportation task can be fulfilled immediately by a luxury car within three kilometers of distance or an ordinary car in an area of three to five kilometers distance from the passenger.

Embodiments of the disclosure address the above problem by computer-implemented methods and systems for generating a second transportation service request comprising a transportation parameter different from that of a first transportation service request.

### SUMMARY

Embodiments of the disclosure provide a computer-implemented method for providing transportation service. The method can include receiving, from a remote passenger terminal, a first transportation service request and determining, by a processor, a first estimated waiting time of the first transportation service request. The method can further include determining, by the processor, that the first estimated waiting time is greater than a first predetermined time period and generating, by the processor, a second transportation service request comprising a transportation parameter different from that of the first transportation service request.

Embodiments of the disclosure further provide a device for providing transportation service. The device can include a communication interface configured to receive, from a remote passenger terminal, a first transportation service request. The device can further include a memory and at least one processor coupled to the communication interface and memory. The at least one processor can be configured to determine a first estimated waiting time of the first transportation service request and determine that the first estimated waiting time is greater than a first predetermined time period. The at least one processor can be further configured to generate a second transportation service request comprising a transportation parameter different from that of the first transportation service request.

Embodiments of the disclosure further provide a non-transitory computer-readable medium that stores a set of instructions, when executed by at least one processor of an electronic device, cause the electronic device to perform a method for providing transportation service. The method can include receiving, from a remote passenger terminal, a first transportation service request. The method can further include determining a first estimated waiting time of the first transportation service request and determining that the first estimated waiting time is greater than a first predetermined time period. The method can also include generating a second transportation service request comprising a transportation parameter different from that of the first transportation service request.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary device for providing transportation service, according to embodiments of the disclosure.

FIG. 2 illustrates a schematic diagram of a passenger, request areas and service vehicles of an exemplary transportation service, according to embodiments of the disclosure.

FIG. 3 illustrates an exemplary diagram of a user interface displayed on a terminal, according to embodiments of the disclosure.

FIG. 4 illustrates another exemplary diagram of a user interface displayed on a terminal, according to embodiments of the disclosure.

FIG. 5 illustrates a flowchart of an exemplary method for providing transportation service, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

An aspect of the disclosure is directed to a device for providing transportation service.

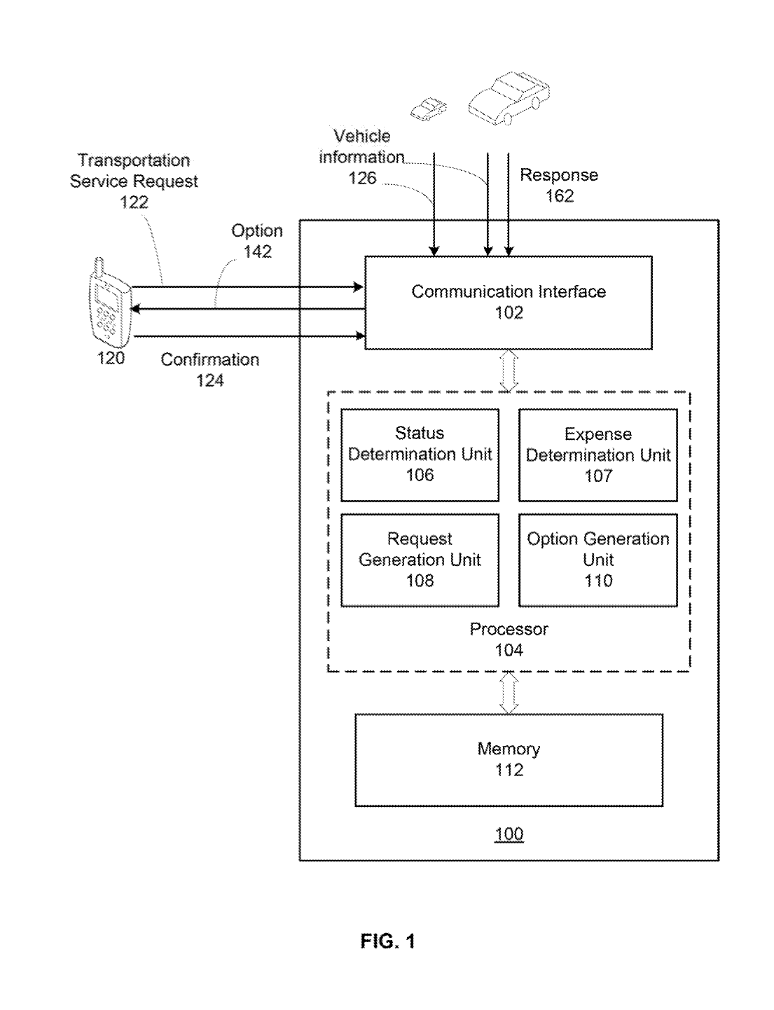

FIG. 1 illustrates a schematic diagram of an exemplary device 100 for providing transportation service, according to embodiments of the disclosure.

Device 100 can be a general-purpose server or a proprietary device specially designed for providing transportation service. It is contemplated that, device 100 can be a separate system (e.g., a server) or an integrated component of a server. Because processing transportation service may require significant computation resources, in some embodiments, device 100 may be preferably implemented as a separate system. In some embodiments, device 100 may include sub-systems, some of which may be remote.

In some embodiments, as shown in FIG. 1, device 100 may include a communication interface 102, a processor 104, and a memory 112. Processor 104 may further include multiple modules, such as a status determination unit 106, an expense determination unit 107, a request generation unit 108, and an option generation unit 110. These modules (and any corresponding sub-modules or sub-units) can be hardware units (e.g., portions of an integrated circuit) of processor 104 designed for use with other components or to execute a part of a program. The program may be stored on a computer-readable medium, and when executed by processor 104, it may perform one or more functions. Although FIG. 1 shows units 106, 107, 108, and 110 all within one processor 104, it is contemplated that these units may be distributed among multiple processors located near or remotely with each other. In some embodiments, device 100 may be implemented in the cloud, or on a separate computer/server.

Communication interface 102 may be configured to receive a first transportation service request 122 from a remote passenger terminal 120. Remote passenger terminal 120 can be any suitable device that can interact with a passenger, e.g., a smart phone, a tablet, a wearable device, a computer, or the like. A transportation service request, e.g., first transportation service request 122, may be associated with a plurality of transportation parameters. The transportation parameters can, for example, include at least one of a current location of the passenger, a request time, an origin and a destination of the requested transportation service, a request area, a vehicle type, a carpooling option, and the like.

Generally, the origin of the requested transportation service can be substantially close to a location of remote passenger terminal 120. However, it is contemplated that, the origin of the requested transportation can also differ from the location of remote passenger terminal 120, though first transportation service request 122 can be sent from remote passenger terminal 120. For example, a user can request a transportation service from a computer for his friend, who is distant from this user.

Request area of a transportation service request can be associated with the transportation service request. For example, the transportation service request (e.g., first transportation service request 122) can be transmitted to all service vehicles within the request area, and service vehicles outside the request area cannot receive the transportation service request. In some embodiments, the request area can be a predetermined area that is set by device 100. For example, the request area can be a hexagonal area that is neighbored with other hexagonal areas. The first transportation request 122 may be firstly transmitted to all service vehicles in a hexagonal area where the origin of the transportation service request locates, and then transmitted to service vehicles in neighbored hexagonal areas. It is contemplated that, the request area can contain shapes other than a hexagon. In some embodiments, the request area can be an area of shape and size dynamically determined, for example, based on the origin of the transportation service request. In some embodiments, the request area may be determined by the user. For example, the user may set a radius value for a circle request area centered at the origin of the transportation service.

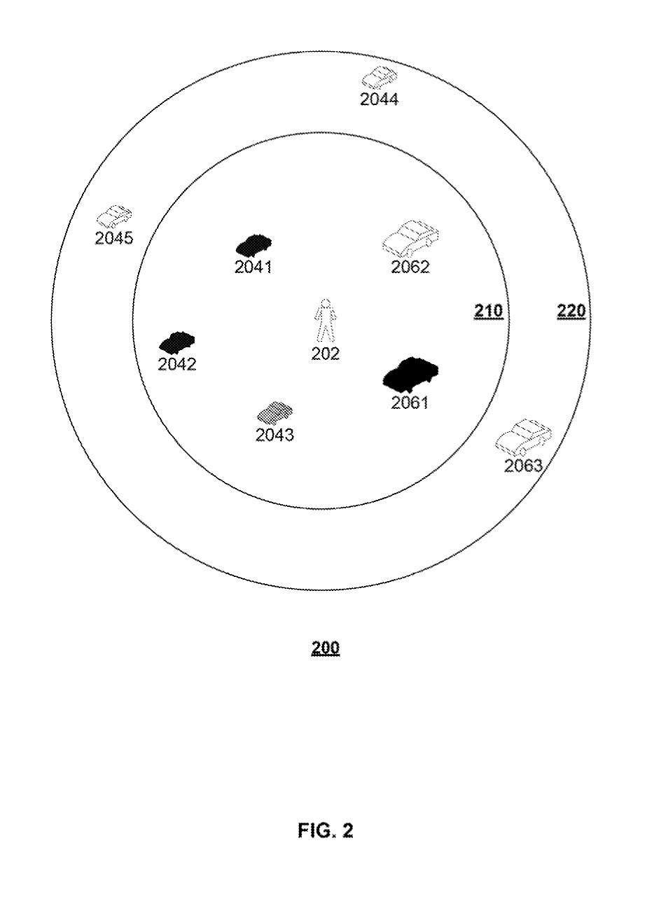

FIG. 2 illustrates a schematic diagram of a passenger 202, a first request area 210, and a second request area 220 and service vehicles of an exemplary transportation service 200 using device 100, according to embodiments of the disclosure. As shown in FIG. 2, first request area 210 is a circular area centered at the current location of passenger 202, e.g., within five kilometers of passenger 202. Second request area 220 is an annular area being more distant from passenger 202 than first request area 210, e.g., additional five to ten kilometers away from passenger 202.

The vehicle type associated with the transportation service request can indicate a type of the requested service vehicle. For example, the vehicles type may include a taxi car (e.g., DiDi Taxi™), an ordinary car (e.g., DiDi Express™), a luxury car (e.g., DiDi Premier™), a bus (e.g., DiDi Bus™ and DiDi Minibus™), etc. It is contemplated that, the service vehicles may also include a type of autonomous vehicles.

The carpooling option can indicate whether a transportation service request is a carpooling request or a non-carpooling request. A carpooling request may allow more than one passengers to share a ride, which results in a lower estimated expense than a non-carpooling request.

In FIG. 2, for example, there are two types of service vehicles: ordinary cars (e.g., cars 2041, 2042, 2043, 2044, and 2045) and luxury cars (e.g., cars 2061, 2062 and 2063). Status of a service vehicle is indicated by the color of the service vehicle in FIG. 2. For example, cars 2041, 2042 and 2061 in black are fully loaded with passengers. Car 2043 in grey is partially loaded, and can respond to a carpooling request. Cars 2044, 2045, 2062 and 2063 in white are not loaded with any passenger and can respond to either a carpooling request or a non-carpooling request.

A transportation request can be associated with transportation parameters including a request area, a vehicle type, and a carpooling option. For example, first transportation request 122 may be associated with first request area 210, ordinary car, and a non-carpooling option.

With reference back to FIG. 1, communication interface 102 can be an integrated services digital network (ISDN) card, cable modem, satellite modem, or a modem to provide a data communication connection. As another example, communication interface 102 can be a local area network (LAN) card to provide a data communication connection to a compatible LAN. Wireless links can also be implemented by communication interface 102. In such an implementation, communication interface 102 can send and receive electrical, electromagnetic or optical signals that carry digital data streams representing various types of information via a network. The network can typically include a cellular communication network, a Wireless Local Area Network (WLAN), a Wide Area Network (WAN), or the like.

Communication interface 102 may be further configured to receive vehicle information 126 from service vehicles. Vehicle information 126 can include at least one of locations, capacities, current driving directions, vehicle models, or other features of the service vehicles.

First transportation service request 122 may be assigned to a request queue by processor 104. Before the assignment, processor 104 may further determine whether the queuing should be activated. In some embodiments, when ordinary cars in first request area 210 can provide enough capacities to passengers, first transportation service request 122 does not have to be queued. In some embodiments, processor 104 may queue transportation service requests for ordinary cars in first request area 210 when the total number of the transportation service requests exceeds the capacity provided by ordinary cars in first request area 210 by a predetermined value, or when first transportation service request 122 is made within a predetermined time range. For example, the predetermined time range can be rush hours (e.g., 8:00-9:00 AM and 5:00-7:00 PM).

Status determination unit 106 can determine a first estimated waiting time of first transportation service request 122. An estimated waiting time (e.g., the first estimated waiting time) for a transportation service request to be fulfilled can be determined based on the transportation service request, real-time vehicle information 126, and request queue status.

In some embodiments, the estimated waiting time for the transportation service request can be determined based on historical data. For example, status determination unit 106 can determine the estimated waiting time using machine learning. The historical data can include sample data and supervised signal. The sample data can include an origin, a destination, a requested time, a location, a position in a waiting queue, a number of previous requests in the waiting queue of a historical request. The supervised signal can include the actual waiting time of the historical request. Based on the sample data and the supervised signal, device 100 can train a machine learning model, which can further estimate the waiting time according to features of a transportation service request. It is contemplated that, status determination unit 106 can continuously determine the estimated waiting time during the whole process of waiting for a response, to periodically update the estimated waiting time, for example, every five seconds.

In some embodiments, status determination unit 106 can also determine other status information (e.g., queuing information) of first transportation service request 122. The queuing information may include a number of waiting requests ahead of first transportation service request 122 and a total number of requests in the request queue.

The status information of first transportation service request 122, including the first estimated waiting time, may be sent to remote passenger terminal 120. Passenger 202 may receive the status information that can be displayed on the remote passenger terminal 120, or played using an audio signal. The status information provided to passenger 202 may be updated periodically, allowing passenger 202 to monitor the status of first transportation service request 122. Furthermore, some notices may be also provided to passenger 202 along with the status information. For example, when the first estimated waiting time is less than one minute, a notice can be generated and provided to passenger 202, such as “your request is being processed”. When the first estimated waiting time is greater than ten minutes, another notice may be generated and displayed, such as “Too many requests now. Please wait in a queue. Thank you for your patience.”.

In some embodiments, the estimated waiting time determined by status determination unit 106 may be directly transmitted to the passenger. In some embodiments, status determination unit 106 can determine a range that the estimated time belongs to and determine a waiting time to be displayed to a passenger according to the range. For example, as for an estimated waiting time of one minute 30 seconds, status determination unit 106 can determine the estimated waiting time belongs to a range of “one-two minutes” and the waiting time according to this range can be displayed as “three minutes”. That is, the waiting time may be measured by minutes, and the waiting time displayed to a passenger can be greater than the estimated waiting time. Similarly, as for another estimated waiting time of two minute 30 seconds, status determination unit 106 can determine the estimated waiting time belongs to a range of “two-five minutes” and the waiting time according to this range can be displayed as “five minutes”. In some embodiments, an estimated waiting time rounded to the next minute can provide better user experience.

Furthermore, processor 104 may further include expense determination unit 107 configured to determine a first estimated expense of first transportation service request 122. An estimated expense of a transportation service request (e.g., the first estimated expense) can be determined based on the distance between the origin and destination of the request, the vehicle type, the unit price of the vehicle type, the remote dispatch option, the carpooling option, and the like. The first estimated expense may also be sent to the remote passenger terminal 120 for providing to passenger 202.

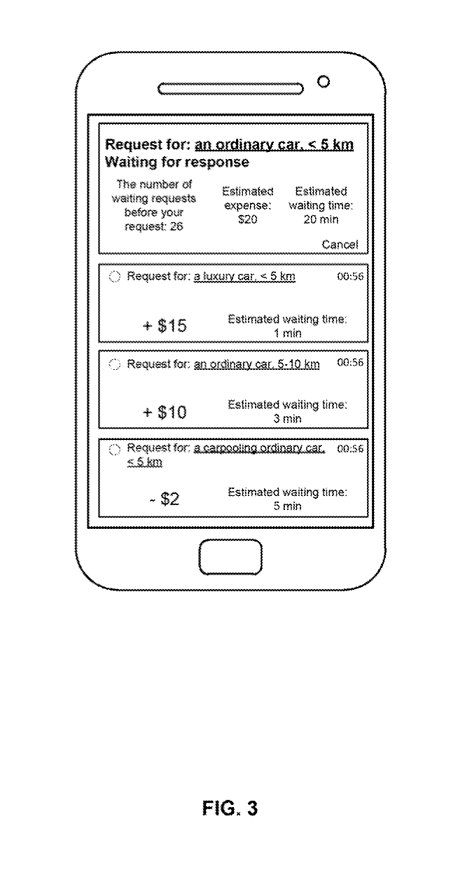

FIG. 3 illustrates an exemplary diagram of a user interface displayed on remote passenger terminal 120, according to embodiments of the disclosure. As shown in FIG. 3, for example, first transportation service request 122 and its status and expense information are displayed on the upper part of the user interface. In some embodiments, the status information may include a first estimated waiting time, e.g., 20 minutes, and queuing information, e.g., “The number of waiting requests before your request is 26”.

When the first estimated waiting time is too long (e.g., 20 minutes shown in FIG. 3), the passenger's schedule may be jeopardized. To reduce waiting time and find an available service vehicle for passenger 202 as soon as possible, a second transportation service request may be generated for the passenger to cover more service vehicles.

Request generation unit 108 of processor 104 may be configured to generate the second transportation service request comprising at least one transportation parameter different from that of first transportation service request 122. In some embodiments, the changed transportation parameter may be the vehicle type, the request area, the carpooling option and the like. With at least one different transportation parameter, the second transportation service request may be answered by service vehicles that are not covered by first transportation service request 122.

In some embodiments, the second transportation service request may be generated if the first estimated waiting time is greater than a first predetermined time period (e.g., ten minutes). It is contemplated that, the first predetermined time period can be adaptively set according to a region, a current time, or other features of the transportation service request. If the first estimated waiting time is greater than the first predetermined time period, request generation unit 108 may generate the second transportation service request. If the first estimated waiting time is within the first predetermined time period, indicating that first transportation service request 122 will be processed quickly, the second transportation service request may not be generated.

In some embodiments, some of the transportation parameters (e.g., the origin and the destination) may remain the same between the first and the second transportation service requests while other parameters may be changed. For example, first transportation service request 122 can be associated with transportation parameters including the ordinary car, first request area 210, the non-carpooling option, and the like. The second transportation service request can be different in at least one of the transportation parameters. For example, the second transportation service request can be associated with a vehicle type other than the ordinary car, a request area other than first request area 210 and/or a carpooling option.

In some embodiments, the second transportation service request may be generated after the passenger's approval. Thus passenger 202 can decide whether to generate the second transportation service request or not. For example, before generating the second transportation service request, communication interface 102 may receive a confirmation 124 approving generation of the second transportation service request from remote passenger terminal 120. However, in some other embodiments, the second transportation service request may be generated by request generation unit 108 automatically without receiving confirmation 124 from remote passenger terminal 120. Although it is described as generating a second transportation service request in this disclosure, it may also be implemented as modifying the first transportation service request. In other words, a second transportation service request may not be separately generated, but obtained by modifying the first transportation service request.

To receive confirmation 124 of generating the second transportation service request from remote passenger terminal 120, an option 142 to modify first transportation service request 122 into the second transportation service request may be provided to remote passenger terminal 120. Therefore, processor 104 may further include an option generation unit 110 configured to generate option 142. Communication interface 102 may be further configured to send option 142 to remote passenger terminal 120 for displaying to passenger 202, and receive confirmation 124 from remote passenger terminal 120.

In some embodiments, option 142 may be a query of whether to generate the second transportation service request. For example, the query may be “Do you want to generate a second transportation service request to reduce wait time?” If communication interface 102 receives a confirmation, e.g., “YES”, the second transportation service request will be generated. If communication interface 102 does not receive any confirmation of option 142, or receives a rejection, e.g., “NO”, the second transportation service request will not be generated.

In some embodiments, option 142 may indicate the transportation parameter of the second transportation service request which is different from that of first transportation service request 122. With the transportation parameter information, it might be easier for passenger 202 to know how first transportation service request 122 is modified and what is in the second transportation service request. For example, option 142 may be one of Options 1˜3 shown in Table 1.

Its estimated waiting time and estimated expense of option 142 can also be determined. And the determination method for option 142 may be the same as the determination method for transportation service requests. Therefore, status determination unit 106 may be further configured to determine estimated waiting time for option 142. Similarly, expense determination unit 107 may be further configured to determine estimated expense for option 142. In certain embodiments, an expense difference between the first estimated expense and the estimated expense of option 142 may be provided to remote passenger terminal 120, e.g., “estimated extra $5 expense”, “estimated $3 less expense”. The estimated waiting time and estimated expense of Options 1˜3 are also listed in Table 1.

TABLE 1

| | | | Carpooling | Estimated | Estimated |
|---|---|---|---|---|---|
| | Request area | Vehicle Type | Option | Waiting Time | Expense |
| First transportation | Request area 210 | Ordinary | Non-carpooling | 20 min | $20 |
| service request 122 | | | | | |
| Option 1 | Request area 210 | Luxury | Non-carpooling | 1 min | +$15 |
| Option 2 | Request area 220 | Ordinary | Non-carpooling | 3 min | +$00 |
| Option 3 | Request area 210 | Ordinary | Carpooling | 5 min | −$2 |

Option 1 in Table 1 is generated by modifying vehicle type of first transportation service request 122. First transportation service request 122 is associated with ordinary cars 2041, 2042, 2043, 2044, and 2015, and Option 1 is associated with luxury cars 2061, 2062, and 2063. Since there are available luxury cars 2062 in first request area 210 (see FIG. 2), the estimated waiting time is very short. Because the unit price of luxury cars is higher than unit price of ordinary cars, the estimated expense of Option 1 is higher than the first estimated expense.

Furthermore, another option may be generated with a lower level vehicle type than ordinary cars, e.g., economy cars. The option of economy cars may be associated with an estimated expense lower than the original estimated expense.

Option 2 in Table 1 is generated by modifying request area of first transportation service request 122. Option 2 is a remote dispatch request. As shown in FIG. 2, there are available ordinary cars 2044, 2045 in second request area 220. But as they are far away from passenger 202, the estimated waiting time may be a little longer than that of Option 1. The estimated expense of Option 2 may be a sum of the first estimated expense and an estimated remote dispatch expense. The estimated remote dispatch expense may be calculated based on a predetermined remote dispatch unit price and a distance between first request area 210 and second request area 220.

The second transportation service request may be generated based on Option 2. If a response from an ordinary car in second request area 220 is received by communication interface 102, an actual remote dispatch expense M may be calculated for the responding vehicle by expense determination unit 107. In some embodiments, M is determined based on a distance of the responding vehicle. As an example, M=(S1-S2)×N, wherein S1 represents a distance between the responding vehicle and passenger 202, S2 represents the maximum distance between passenger 202 and a point in the first request area (e.g. radius value of first request area 210 in FIG. 2), and N represents a predetermined remote dispatch unit price. The value of N may be varied according to current time, region, weather conditions, traffic conditions, and the like. The total actual expense for the responding vehicle is a sum of the actual remote dispatch expense and a transportation expense from origin to destination of the transportation service.

In some embodiments, the option may be generated with a third request area being more distant from passenger 202 or the origin than that of second request area 220 when there is no available ordinary car in second request area 220.

Option 3 in Table 1 may be generated by modifying carpooling option of first transportation service request 122. For example, first transportation service request 122 may be a non-carpooling request, and Option 3 may change it to a carpooling request. Since there are available ordinary cars 2043 available for carpooling in first request area 210, the estimated waiting time of Option 3 may be very short. The estimated expense of Option 3 may also be lower than the first estimated expense.

When multiple possible options are available to modify first transportation service request 122, option 142 may be generated according to a predetermined regulation. In some embodiments, option 142 may be generated by modifying one parameter at a time according to a predetermined order, e.g., vehicle type, request area, and then carpooling option, to check if there is any available service vehicle.

In some embodiments, option generation unit 110 may be configured to identify and evaluate a plurality of possible options, select and generate one or more, for example, up to three, options. Thus option 142 may include more than one, e.g., up to three, options. The evaluation and selection may be conducted based on estimated waiting time and/or estimated expense of each option.

Communication interface 102 may provide option 142 to remote passenger terminal 120 for displaying to passenger 202. The estimated waiting time and estimated expense of option 142 may be also provided to remote passenger terminal 120, which could help passenger 202 make a decision quickly. For example, as shown in FIG. 3, Options 1˜3 in Table 1 are provided to remote passenger terminal 120 and displayed on the user interface of remote passenger terminal 120.

In some embodiments, option 142 can be provided to remote passenger terminal 120 for a second predetermined time period. During the second predetermined time period (e.g., one minute or two minutes), option 142 (e.g., including the second estimated waiting time and the second estimated expense) is shown to the passenger until a confirmation is received from remote passenger terminal 120 by communication interface 102. For example, a countdown timer (e.g., one minute countdown as shown in FIG. 3), along with option 142, may be shown to the passenger on remote passenger terminal 120. If no confirmation of option 142 is received from remote passenger terminal 120 before the second predetermined time period expires, option 142 may be withdrawn by processor 104 and the display of option 142 on remote passenger terminal 120 may disappear.

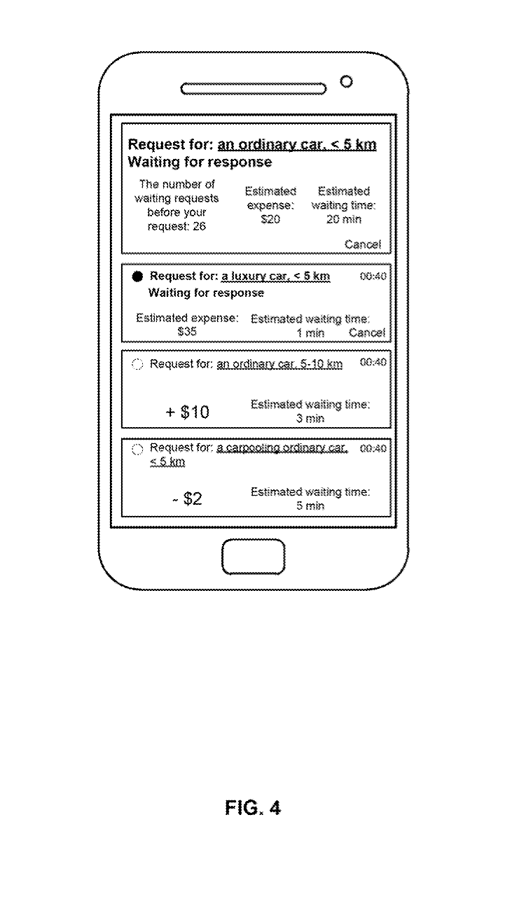

Request generation unit 108 may generate the second transportation request based on option 142 after confirmation 124 of option 142 is received by communication interface 102. FIG. 4 illustrates another exemplary diagram of a user interface displayed on remote passenger terminal 120, according an embodiment of the disclosure. As shown in FIG. 4, Option 1 has been confirmed by passenger 202, and a second transportation service request corresponding to Option 1 has been generated by request generation unit 108. Status indication of “Waiting for response” is shown on the user interface. Even at this time, since the one minute countdown is not finished, Option 2 and/or Option 3 can also be confirmed by passenger 202 to generate another one or two transportation service requests.

Status determination unit 106 may be further configured to determine second status information, e.g., a second estimated waiting time and second queuing information, for the second transportation service request. Expense determination unit 107 may be further configured to determine a second estimated expense for the second transportation service request. The second status information and/or the second estimated expense may be provided to the remote passenger terminal 120 for displaying to passenger 202. As the second transportation service request is generated based on option 142, the estimated waiting time of option 142 may become the second estimated waiting time, which is updated periodically. The second estimated expense may be the same as the estimated expense of option 142.

In some embodiments, the second estimated waiting time is shorter than the first estimated waiting time, indicating that the second transportation service request may be responded earlier than first transportation service request 122.

In some embodiments, after the second transportation request is generated by request generation unit 108, the first transportation request may be kept active. Thus both the first and the second transportation requests may be active until either one is processed, or responded by a service vehicle. As the first and the second transportation requests are usually placed in different queues (e.g., carpool queue v. non-carpool queue), keeping both of them in processing can increase the chance of the requests being responded by an available service vehicle as soon as possible.

In some embodiments, each of the transportation service requests can be canceled by processor 104 after receiving a cancelation instruction from remote passenger terminal 120, before it is responded by a service vehicle. As shown in FIG. 4, a cancelation option is shown on the user interface for each of the transportation service requests.

The above embodiments of device 100 can generate a second transportation service request comprising at least one transportation parameter different from that of first transportation service request 122 when the first estimated waiting time is greater than a first predetermined time period. Thus, the disclosed embodiments of device 100 can help passenger 202 find an available service vehicle as soon as possible, reduce waiting time, and make the best use of transportation capacities.

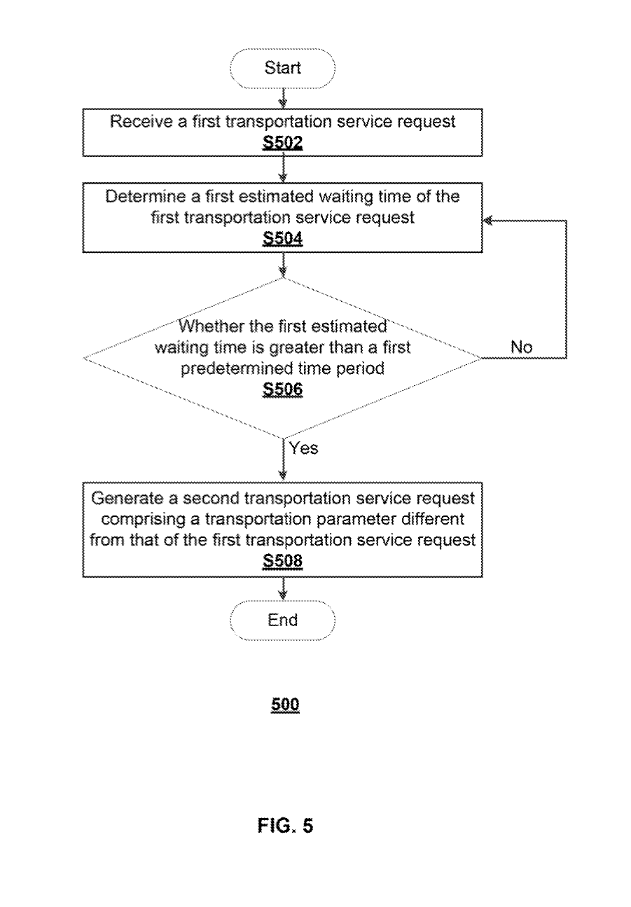

Another aspect of the disclosure is directed to a method for providing transportation service. FIG. 5 illustrates a flowchart of a method 500 for providing transportation service, according to embodiments of the disclosure. For example, method 500 may be implemented by device 100 including at least one processor 104, and method 500 may include steps S502, S504, S506 and S508 as described below.

In step S502, device 100 may receive a first transportation service request from a remote passenger terminal. The first transportation service request may be associated with a plurality of transportation parameters. The transportation parameters can, for example, include at least one of a current location of the passenger, a request time, an origin and a destination of the requested transportation service, a request area, a vehicle type, a carpooling option, and the like. For example, the first transportation request may be associated with a first request area, ordinary cars, and a non-carpooling option.

Device 100 may also receive vehicle information from service vehicles. The vehicle information can include at least one of locations, capacities, current driving directions, vehicle models, or other features of the service vehicles.

The first transportation service request may be assigned to a request queue by processor 104. For example, processor 104 may queue transportation service requests for ordinary cars in the first request area when the total number of the transportation service requests exceeds the capacity provided by ordinary cars in the first request area by a predetermined value, or when the first transportation service request is made within a predetermined time range. For example, the predetermined time range can be rush hours (e.g., 8:00-9:00 AM and 5:00-7:00 PM).

In step S504, device 100 may determine a first estimated waiting time of the first transportation service request. The first estimated waiting time may be determined based on the first transportation service request, real-time vehicle information, and request queue status. Besides the first estimated waiting time, other status information, e.g., queuing information, may be also determined by device 100. The queuing information may include a number of waiting requests ahead of the first transportation service request and a total number of requests in the request queue. The status information of the first transportation service request, including the first estimated waiting time, may be provided to the passenger through displaying or audio signal. The status information of the first transportation service request may be updated periodically, allowing the passenger to monitor the status of the first transportation service request.

Furthermore, a first estimated expense of the first transportation service request may be also determined by device 100. The first estimated expense can be determined based on the distance between the origin and destination of the request, the vehicle type, the unit price of the vehicle type, the remote dispatch option, the carpooling option, and the like. The first estimated expense may also be provided to the passenger.

In step S506, device 100 may determine whether the first estimated waiting time is greater than a first predetermined time period, e.g., ten minutes. It is contemplated that, the first predetermined time period can be adaptively set according to a region, a current time, or other features of the transportation service request.

In step S508, device 100 may generate a second transportation service request if the first estimated waiting time is greater than the first predetermined time period. The second transportation service request may comprise at least one transportation parameter different from that of the first transportation service request. In some embodiments, the changed transportation parameter may be the vehicle type, the request area, the carpooling option and the like. With at least one different transportation parameter, the second transportation service request may be answered by service vehicles that are not covered by the first transportation service request. If the first estimated waiting time is within the first predetermined time period, indicating that the first transportation service request will be processed quickly, the second transportation service request may not be generated. Although it is described as generating a second transportation service request in this disclosure, it may also be implemented as modifying the first transportation service request. In other words, a second transportation service request may not be separately generated, but obtained by modifying the first transportation service request.

In some embodiments, some of the transportation parameters (e.g., the origin and the destination) may remain the same between the first and the second transportation service requests while other parameter may be changed. For example, the first transportation service request can be associated with transportation parameters including the ordinary car, the first request area, the non-carpooling option, and the like. The second transportation service request can be different in at least one of the transportation parameters. For example, the second transportation service request can be associated with a vehicle type other than the ordinary car, a request area other than the first request area and/or a carpooling option.

In some embodiments, the second transportation service request may be generated after the passenger's approval. Thus passenger can decide whether to generate the second transportation service request or not. Device 100 may receive a confirmation approving generation of the second transportation service request before generating the second transportation service request.

To receive the confirmation of generating the second transportation service request, device 100 may generate an option to modify the first transportation service request into the second transportation service request.

In some embodiments, the option may be a query of whether to generate the second transportation service request. For example, the query may be “Do you want to generate a second transportation service request to reduce wait time?” In some other embodiments, the option may indicate the transportation parameter of the second transportation service request which is different from that of the first transportation service request. With the transportation parameter information, it might be easier for the passenger to know how first transportation service request is modified and what is in the second transportation service request. Device 100 may also determine an estimated waiting time and an estimated expense of the option. And the determination method for the option may be the same as the determination method for transportation service requests. In certain embodiments, an expense difference between the first estimated expense and the estimated expense of the option may be provided to the passenger, e.g., “estimated extra $5 expense”, “estimated $3 less expense”.

Device 100 may provide the option including the estimated waiting time and/or the estimated expense thereof to the remote passenger terminal, and receive the confirmation of generating the second transportation service request.

In some embodiments, the option is provided to the passenger for a second predetermined time period, e.g., one minute or two minutes. During the second predetermined time period, the provided option is shown to the passenger until a confirmation is received from the remote passenger terminal. A countdown timer may be shown to the passenger on the remote passenger terminal. If no confirmation of the option is received from the remote passenger terminal before the second predetermined time period expires, the option may be withdrawn by processor 104 and the display of the option on the remote passenger terminal may disappear.

The second transportation service request may be generated based on the option after the confirmation is received from the remote passenger terminal. However, the second transportation service request may also be generated by device 100 automatically without receiving the confirmation.

Device 100 may determine a second estimated waiting time and a second estimated expense for the second transportation service request. The second estimated waiting time and/or the second estimated expense may be provided to the remote passenger terminal for displaying to the passenger. As the second transportation service request is generated based on the option, the estimated waiting time of the option may become the second estimated waiting time, which is updated periodically. The second estimated expense may be the same as the estimated expense of the option.

In some embodiments, the second estimated waiting time is shorter than the first estimated waiting time, indicating that the second transportation service request may be responded earlier than the first transportation service request.

In some embodiments, after the second transportation request is generated, the first transportation request may be kept active. Thus both the first and the second transportation requests may be active until either one is processed, or responded by a service vehicle. As the first and the second transportation requests are usually placed in different queues (e.g., carpool queue v. non-carpool queue), keeping both of them in processing can increase the chance of the requests being responded by an available service vehicle as soon as possible.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A computer-implemented method for providing transportation service, comprising:
receiving, from a remote passenger terminal, a first transportation service request;
determining, by a processor, a first estimated waiting time of the first transportation service request;
determining, by the processor, that the first estimated waiting time is greater than a first predetermined time period; and
generating, by the processor, a second transportation service request comprising a transportation parameter different from that of the first transportation service request.

2. The computer-implemented method of claim 1, wherein the transportation parameter comprises at least one of request area, vehicle type, and carpooling option.

3. The computer-implemented method of claim 1, wherein the first transportation service request is active until the second transportation service request is processed.

4. The computer-implemented method of claim 1, further comprising:
determining, by the processor, a second estimated waiting time of the second transportation service request.

5. The computer-implemented method of claim 4, wherein the second estimated waiting time is shorter than the first estimated waiting time.

6. The computer-implemented method of claim 1, further comprising:
generating, by the processor, an option to modify the first transportation service request into the second transportation service request; and
generating, the second transportation service request based on the option.

7. The computer-implemented method of claim 6, further comprising:
providing the option to the remote passenger terminal;
receiving, from the remote passenger terminal, a confirmation of the option; and
generating the second transportation service request based on the confirmed option.

8. The computer-implemented method of claim 1, wherein the first transportation service request is associated with a first request area and the second transportation service request is associated with a second request area more distant from the remote passenger terminal than the first request area.

9. The computer-implemented method of claim 1, wherein the second transportation service request comprises a vehicle type different from that of the first transportation service request.

10. The request processing method of claim 1, wherein the second transportation service request differs from the first transportation request in a carpooling option.

11. A device for providing transportation service, comprising:
a communication interface configured to receive, from a remote passenger terminal, a first transportation service request;
a memory; and
at least one processor coupled to the communication interface and the memory, configured to:
determine a first estimated waiting time of the first transportation service request;
determine that the first estimated waiting time is greater than a first predetermined time period; and
generate a second transportation service request comprising a transportation parameter different from that of the first transportation service request.

12. The device of claim 11, wherein the transportation parameter comprises at least one of request area, vehicle type, and carpooling option.

13. The device of claim 11, wherein the first transportation service request is active until the second transportation service request is processed.

14. The device of claim 11, wherein the at least one processor is further configured to determine a second estimated waiting time of the second transportation service request, wherein the second estimated waiting time is shorter than the first estimated waiting time.

15. The device of claim 11, wherein the at least one processor is further configured to:
generate an option to modify the first transportation service request into the second transportation service request; and
generate the second transportation service request based on the option.

16. The device of claim 15, wherein the at least one processor is further configured to provide the option to the remote passenger terminal, and the communication interface is further configured to receive, from a remote passenger terminal, a confirmation of the option.

17. The device of claim 11, wherein the first transportation service request is associated with a first request area and the second transportation service request is associated with a second request area more distant from the remote passenger terminal than the first request area.

18. The device of claim 11, wherein the second transportation service request comprises a vehicle type different from that of the first transportation service request.

19. The device of claim 11, wherein the second transportation service request differs from the first transportation request in a carpooling option.

20. A non-transitory computer-readable medium that stores a set of instructions, when executed by at least one processor of an electronic device, cause the electronic device to perform a request processing method for providing transportation service, the method comprising:
receiving, from a remote passenger terminal, a first transportation service request;
determining a first estimated waiting time of the first transportation service request;
determining that the first estimated waiting time is greater than a first predetermined time period; and
generating a second transportation service request comprising a transportation parameter different from that of the first transportation service request.
